(19) United States
(12) Patent Application Publication
(10) Pub. No.: US 2019/0316529 A1
(43) Pub. Date: Oct. 17, 2019

(54) METHOD AND SYSTEM FOR CONTROLLING AN INTERNAL COMBUSTION ENGINE

(71) Applicant: SCANIA CV AB, Södertälje (SE)

(72) Inventors: John GAYNOR, Hölö (SE); Torbjörn ELIASSEN, Nykvarn (SE); Andreas DAHL, Nyköping (SE)

(73) Assignee: SCANIA CV AB, Södertälje (SE)

(21) Appl. No.: 16/343,421

(22) PCT Filed: Oct. 11, 2017
(86) PCT No.: PCT/SE2017/050999

§ 371 Date: Apr. 19, 2019

(30) Foreign Application Priority Data
Oct. 19, 2016 (SE) 1651366-5

(51) Int. Cl. F02D 13/02; F02B 25/14; F02B 37/007; F02B 37/02; F02D 41/00

(52) U.S. Cl. CPC F02D 13/0261; F02B 25/145; F02D 13/0219; F02B 37/007; F02D 2041/001; F02D 41/0007; F02D 2200/101; F02D 2200/1002; F02B 37/025

(57) ABSTRACT

The present invention relates to method for controlling a compression-ignition internal combustion engine, said internal combustion engine having at least one combustion chamber, wherein intake of air to said combustion chamber is controlled using an intake valve, and wherein evacuation of said combustion chamber is controlled using an exhaust valve. The method includes: controlling opening of said intake valve and closing of said exhaust valve in dependence of the position of a reciprocating member in said combustion chamber, wherein opening of said intake valve and closing of said exhaust valve, respectively, in relation to the position of said reciprocating member is individually controllable, and wherein, in one mode of operation, opening of said intake valve and closing of said exhaust valve, respectively, are controlled such that both valves are simultaneously open during a period of variable length.

### CROSS-REFERENCE TO RELATED APPLICATION(S)

This application is a national stage application (filed under 35 § U.S.C. 371) of PCT/SE2017/050999, filed Oct. 11, 2017 of the same title, which, in turn, claims priority to Swedish Application No. 1651366-5 filed Oct. 19, 2016; the contents of each of which are hereby incorporated by reference.

### FIELD OF THE INVENTION

The present invention relates to combustion processes, and in particular to a method and system for controlling an internal combustion engine. The present invention also relates to a vehicle, as well as a computer program and a computer program product that implement the method according to the invention.

### BACKGROUND OF THE INVENTION

With regard to vehicles in general, and at least to some extent heavy/commercial vehicles such as trucks, buses and the like, there is constantly ongoing research and development with regard to increasing fuel efficiency and reducing exhaust emissions.

This is often at least partly due to growing governmental concern in pollution and air quality, e.g. in urban areas, which has also led to the adoption of various emission standards and rules in many jurisdictions.

These emission standards often consist of requirements that define acceptable limits for exhaust emissions of vehicles being provided with internal combustion engines. For example, the exhaust levels of e.g. nitric oxides (NOₓ), hydrocarbons (HC), carbon monoxide (CO) and particles are regulated for most kinds of vehicles in these standards.

Undesired emission of substances can be reduced by reducing fuel consumption and/or through the use of aftertreatment (purifying) of the exhaust gases that results from the combustion process.

Exhaust gases from the internal combustion engine can, for example, be treated through the use of a catalytic process. There exist various kinds of catalytic converters, where different types can be used for different kinds of fuel and/or for treatment of different kinds of substances occurring in the exhaust gas stream. For example, a common kind of catalytic converters that are used in particular for reduction of nitric oxides, NOₓ, is Selective Catalytic Reduction (SCR) catalytic converters.

Catalytic converters being used for aftertreatment of an exhaust gas stream in general have in common that at least a minimum temperature must be maintained in the catalytic converter in order to ensure that desired reactions occur. Furthermore, the catalytic converters may also be temperature sensitive in the regard that too high temperatures may be damaging.

Furthermore, there is a general tendency towards down-speeding of internal combustion engines in order to further reduce fuel consumption. High loads at low engine speeds, however, may impose additional challenges on combustion engine operation.

### SUMMARY OF THE INVENTION

It is an object of the present invention to provide a method and system that controls operation of a compression-ignition internal combustion engine, and, in particular, improved combustion chamber scavenging. For example, an intake valve and an exhaust valve can be controlled to obtain desired scavenging of a combustion chamber in dependence of current operating conditions of the internal combustion engine. This object is achieved by a method according to claim 1.

According to the present invention, it is provided a method for controlling a compression-ignition internal combustion engine, said internal combustion engine having at least one combustion chamber, wherein intake of air to said combustion chamber is controlled using an intake valve, and wherein evacuation of said combustion chamber is controlled using an exhaust valve. The method includes:

controlling opening of said intake valve and closing of said exhaust valve in dependence of the position of a reciprocating member in said combustion chamber, wherein opening of said intake valve and closing of said exhaust valve, respectively, in relation to the position of said reciprocating member is individually controllable, and

wherein, in one mode of operation, opening of said intake valve and closing of said exhaust valve, respectively, are controlled such that both valves are simultaneously open during a period of variable length.

Said reciprocating member may, for example, be a reciprocating piston in said combustion chamber. The internal combustion engine may further comprise a fixed geometry turbocharger.

Exhaust gases arising from combustion in a combustion chamber of an internal combustion engine are evacuated in order to again fill the combustion chamber with air or air/fuel of a following combustion. This process of evacuating exhaust gases and filling the combustion chamber with air or air/fuel of a following combustion is called scavenging. Scavenging is performed through the use of one or more exhaust valves, which open a passage to an exhaust manifold, and one or more intake valves that open a passage to an intake conduit for intake of air for use in combustion.

The exhaust gases resulting from combustion are in general treated prior to being released into the surroundings, such as surroundings of a vehicle. There are various ways of treating these exhaust gases in order to reduce harmful emissions into the surroundings of the vehicle. For example, it is common, at least with regard to heavy/commercial vehicles, that nitric oxides NOₓ are reduced.

The generation of nitric oxides NOₓ is highly temperature dependent, where higher amounts are generated at higher combustion temperatures. The amount of nitric oxides NOₓ in the exhaust gas stream may be reduced prior to the exhaust gas stream being released into the surroundings of the vehicle, for example using a Selective Catalytic Reduction (SCR) catalytic converter. Such reduction may not always be sufficient, and it is also possible to reduce the nitric oxides by recirculating part of the exhaust gases (commonly denoted EGR) in order to reduce the maximum temperature that arises during combustion, and therefore also the amount of nitric oxides NOₓ being generated during the combustion.

There exist, however, systems where aftertreatment is capable of reducing nitric oxides to a satisfactory extent using e.g. an SCR catalytic converter without the need for EGR recirculation. The present invention relates in particular to systems of this kind, although being applicable also in systems utilizing EGR.

Aftertreatment components, such as perhaps in particular SCR catalytic converters, are oftentimes relatively temperature sensitive. For example, if a temperature of the exhaust gases produced by the internal combustion engine reaches too high levels, the hot exhaust gases may damage aftertreatment components, such as e.g. SCR catalytic converters. Since there is a general tendency towards down-speeding and thereby operation of internal combustion engines at high loads at low engine speeds, exhaust temperatures may increase due to lesser amounts of cold air being supplied to the combustion and following aftertreatment. This may be partly due to the lower engine speeds being used, but also due to insufficient evacuation of hot exhausts from the combustion engine, thereby reducing the possibility to supply air to the combustion, resulting in less optimal scavenging.

With regard to scavenging, this essentially means that following a power stroke, an exhaust valve is opened on the piston return stroke towards top dead centre (TDC) to evacuate the exhaust gases prior to a following intake of air.

According to the present invention, it is provided a method for controlling a compression-ignition internal combustion engine in a manner resulting in more efficient scavenging e.g. in situations of the above kind. The invention may also provide additional advantages, or possibilities, by varying operation of the intake valve and exhaust valve in dependence of the combustion engine operating conditions. For example, at higher engine speeds and/or lower internal combustion engine loads, the different conditions may impose other requirements regarding scavenging.

According to the invention it is provided a method where opening of the intake valve, and closing of the exhaust valve, respectively, is individually controlled in dependence of the position of a reciprocating member such as piston. That is, the intake valve may be controlled to be opened at varying piston positions, and hence earlier or later in relation to e.g. when a piston reaches top dead centre (TDC). Correspondingly, the closing of the exhaust valve can also be controlled to occur at varying piston positions, and hence earlier or later in relation to when e.g. a piston reaches TDC.

The intake valve and exhaust valve are hence individually controllable, which allows for various possibilities and in particular the intake valve and exhaust valve at least in one mode of operation are controlled such that both valves are simultaneously open, where the period during which both valves are simultaneously open also can be controlled.

Consequently, opening of the intake valve and closing of the exhaust valve, respectively, can be independently controlled and performed at different and independently varying piston positions for different situations. For example, the valves can be arranged to be controlled in dependence of one or more from: work produced by said internal combustion engine, air/fuel ratio, exhaust temperature and/or the rotational speed of the internal combustion engine.

Hence, according to at least one mode of operation, the intake valve is opened prior to closing the exhaust valve so that intake air passes through the combustion chamber and simultaneously mixes with and evacuates exhaust residuals, i.e. a portion of the exhaust gases remaining in the combustion chamber following an exhaust stroke, so that exhaust residuals remaining in the combustion chamber are substantially reduced. This facilitates evacuation of the combustion chamber so that hot exhausts are evacuated to a higher extent. This improves scavenging since the intake air reduces combustion residuals by facilitating evacuation thereof, and has a cooling effect on the combustion chamber/combustion residuals possibly still remaining in the combustion chamber. If hot residuals remain in the combustion chamber, these will expand during the intake stroke and reduce the amount of air that can be supplied through the intake valve. The reduction of hot residuals therefore allows larger amounts of intake air to be supplied to the combustion chamber in the following intake stroke. In this way e.g. brake thermal efficiency (BTE) of the internal combustion engine is increased.

The air being allowed to pass through the combustion chamber when both exhaust valve and intake valve are open further has the effect of cooling the exhaust gas stream that enters aftertreatment components, and may thereby be used to reduce the risk for the temperature of aftertreatment components reaching harmful temperatures.

Furthermore, since more air can be supplied to the combustion chamber, also more fuel can be supplied, and thereby the power being delivered can be increased. Hence, low speed torque can be increased. This is also useful e.g. in vehicle acceleration, since more air can be provided for each stroke, thereby faster increasing the speed of the turbocharger to faster increase air intake pressure.

The system can preferably be designed/dimensioned so that the engine and turbocharger combination is chosen in such a way that the efficiency of a compressor of the turbocharger increases with increasing mass flow through the compressor and/or the turbine. This is of particular advantage when the engine is operating at low speed and high torque.

This design/dimensioning has the desired consequence that work needed to remove the exhaust gases is reduced so that the overall efficiency gain that is the result of reduced thermal losses in the combustion chamber increases. This is because the decrease in open cycle efficiency (efficiency when at least one valve is open, OCE) is smaller than it would otherwise be due to the dimensioning of the compressor. The gain in closed cycle efficiency (all valves closed, CCE) is larger than the OCE loss, resulting in an overall BTE increase.

According to embodiments of the invention, the internal combustion engine can be controlled according to various modes of operation. For example, according to one mode of operation, the intake valve and exhaust valve can be controlled such that both valves are simultaneously open during a first period. According to a second mode of operation, the intake valve and exhaust valve can be controlled such that both valves are simultaneously open during a second period, being different from said first period. Hence, the period during which both valves are simultaneously open can be controlled.

Furthermore, according to embodiments of the invention, the internal combustion engine can be controlled such that according to one mode of operation, the intake valve and exhaust valve are controlled such that both valves are simultaneously open during a first period of time. According to a second mode of operation, the intake valve and exhaust valve can be controlled such that the exhaust valve closes prior to the intake valve opens.

According to embodiments of the invention, the period can e.g. be a period of time but also e.g. a period represented by a crank shaft movement, e.g. a number of crank shaft degrees. Since the valves can be opened and closed at different positions of the piston in the combustion chamber, opening and closing also can be varied in relation to the crank shaft position (rotation).

Consequently, the difference in crank shaft degrees (i.e. rotation of the crank shaft) between opening of the intake valve in relation to the closing of the exhaust valve may also be varied, e.g. in dependence of the operation of the internal combustion engine.

Further, according to embodiments of the invention, the period during which both intake valve and exhaust valve are open can be determined e.g. in crank angle degree movement. That is, the crank angle interval (rotation) during which both valve are open and intake air is allowed to pass to the exhaust manifold from intake side of the internal combustion engine during scavenging of the combustion chamber can be arranged to vary.

According to embodiments of the invention, a first camshaft is used to control opening and closing of the exhaust valve, and a second camshaft is used to control opening and closing of the intake valve. Both the first and second camshaft can be arranged to be phase shifted (phased), e.g. using phasers, to accomplish control of the valves according to the above. That is, the camshafts can be arranged to comprise a degree of freedom of rotation independent from the rotation of the crank shaft. For example, the camshafts may be designed to allow a phasing corresponding e.g. to any suitable number of crank shaft degrees in the interval 10-100 degrees, where the phasing can be arranged to be both retarding and advancing in relation to crank shaft rotation.

According to embodiments of the invention, the valves are controlled using other suitable means. For example, the valves may be electrically controlled valves.

Furthermore, in dependence of available clearance, the piston may need recesses on the piston head in order to allow valves to be open while the piston reaches TDC in order to avoid conflict with the valves during the overlap phase. Such design issues, however, are known to the person skilled in the art.

As in general is the case, the internal combustion engine may comprise a plurality of combustion chambers. Furthermore, the plurality of combustion chambers can be arranged to be divided into groups, or banks. For example, the combustion chambers may be divided into two banks, where the exhausts from each bank can be arranged to pass through separated exhaust manifolds.

Exhaust manifolds that keep exhausts from the first and second bank separated can be used to prevent pulse-interference between the two banks. Pulse-interference may prevent efficient scavenging during the overlap phase. The bank separation is preferably as complete as possible until the exhaust has passed through e.g. a turbine. For example, a twin scroll turbine with bank separation, e.g. having separate inlets for separate manifolds, may be utilized. Alternatively, e.g. two (or more) turbochargers can be employed, one for each cylinder bank. Following the turbocharger, exhaust gases from all combustion chambers may be mixed to form an aggregated exhaust gas stream e.g. arranged to pass through at least one aftertreatment component for treating said exhaust gas stream.

According to embodiments of the invention, the internal combustion engine consists of an internal combustion engine without exhaust gas recirculation (EGR) from exhaust conduit to intake conduit.

According to embodiments of the invention, the compression-ignition internal combustion engine is an in-line six cylinder internal combustion engine, where the cylinders are divided into two banks, each bank comprising a separate exhaust manifold.

According to embodiments of the invention, camshafts with increased symmetrical valve overlap may be utilized. That is, the valve-open period may be extended in relation to the camshaft normally used for a particular internal combustion engine. In this way exhaust valve opening (EVO) and intake valve closing (IVC) can be kept at similar crank axle degrees (CAD) positions as they would on a “normal” camshaft, while EVC may still be retarded and IVO be advanced resulting in increased valve overlap.

Further characteristics of the present invention and advantages thereof are indicated in the detailed description of exemplary embodiments set out below and the attached drawings.

### BRIEF DESCRIPTION OF THE DRAWINGS

FIG. 1A illustrates a power train of an exemplary vehicle in which the present invention advantageously can be utilized;

FIG. 1B illustrates an example of a control unit in a vehicle control system;

FIG. 2 illustrates an example of a combustion chamber suitable for being controlled according to embodiments of the invention;

FIG. 3 illustrates an exemplary method according to one embodiment of the present invention;

FIG. 4 illustrates an exemplary system involving an in-line six cylinder internal combustion engine being controlled according to embodiments of the present invention; and

FIGS. 5A-E shows exemplary control strategies according to embodiments of the invention.

### DETAILED DESCRIPTION OF THE INVENTION

In the following detailed description, the present invention will be exemplified for a vehicle. The invention is, however, applicable also in other kinds of transportation means, such as air and water crafts. The invention is also applicable in fixed installations. Further the terms “intake valve” and “exhaust valve” are used to denote any means that open and close a passage to a combustion chamber for inlet of air and evacuation of combustion residuals, respectively.

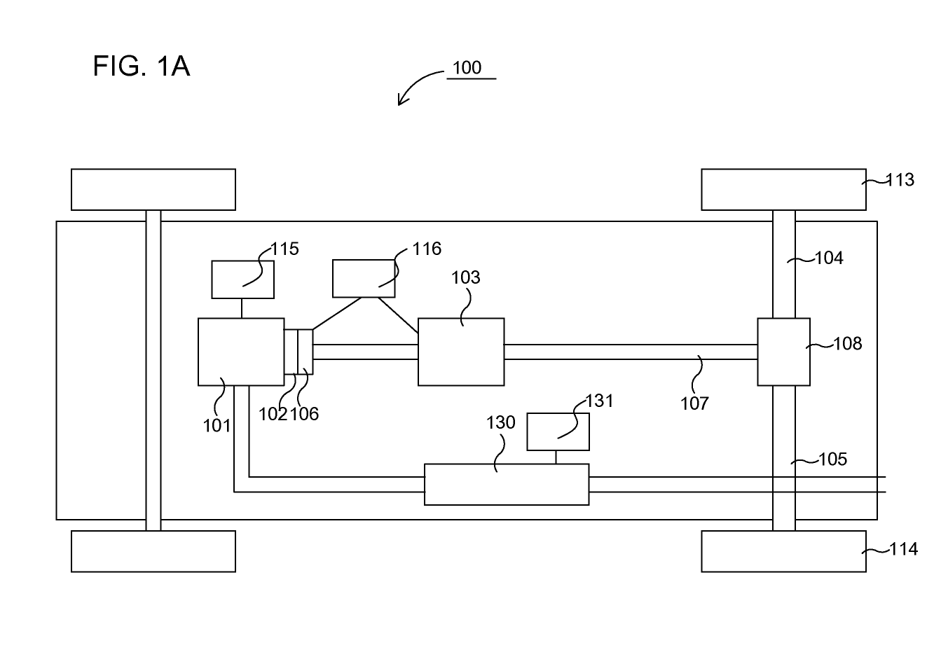

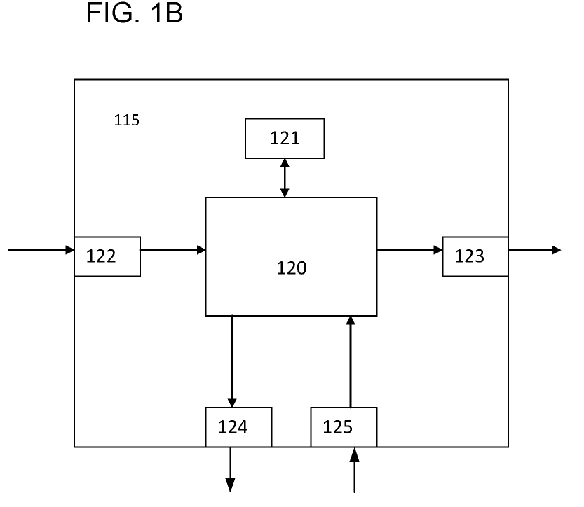

FIG. 1A schematically depicts a power train of an exemplary vehicle 100. The power train comprises a power source, in the present example a compression-ignited internal combustion engine 101 such as a Diesel engine, which, in a conventional manner, is connected via an output shaft of the internal combustion engine 101, normally via a flywheel 102, to a gearbox 103 via a clutch 106. An output shaft 107 from the gearbox 103 propels drive wheels 113, 114 via a final drive 108, such as a common differential, and drive axles 104, 105 connected to said final drive 108.

The internal combustion engine 101 is controlled by the vehicle control system via a control unit 115. The clutch 106 and gearbox 103 are also controlled by the vehicle control system by means of a control unit 116.

FIG. 1A discloses a powertrain of a specific kind, but the invention is applicable for any kind of power train, and also e.g. in hybrid vehicles. The disclosed vehicle further comprises aftertreatment components 130 for aftertreatment (purifying) of exhaust gases that results from combustion in the internal combustion engine 101. The functions of the aftertreatment components 130 are controlled by means of a control unit 131.

The aftertreatment components 130 may be of various kinds and designs. For example, in a manner known per se, the aftertreatment components 130 may include one or more from a diesel oxidation catalytic converter (DOC), which, inter alia, is used to oxidize remaining hydrocarbons and carbon monoxide in the exhaust gas stream. The oxidation can also be used to ensure that aftertreatment components downstream the oxidation catalytic converter 202 maintain a desired minimum temperature. The oxidation catalytic converter 202 may also oxidize nitrogen monoxides (NO) occurring in the exhaust gas stream to nitrogen dioxide (NO₂). This nitrogen dioxide is beneficial, for example, for increasing the efficiency of NOₓ reduction in SCR catalytic converters (see below) where reduction is dependent on the ratio between NO and NO₂ in the exhaust gas stream. Other reactions may also occur in the oxidation catalytic converter DOC 202.

Further, the aftertreatment components may include a diesel particulate filter DPF, e.g. arranged downstream an oxidation catalytic converter, and which basically has the task of collecting particles in the exhaust gas stream.

The aftertreatment components 130 may also comprise a selective catalytic reduction (SCR) catalytic converter, e.g. arranged downstream of the DPF. SCR catalytic converters in general reduce e.g. nitrous oxides NOₓ in the exhaust gas stream through the use of an additive in a manner known per se.

The aftertreatment components 130 may also include further and/or other elements, such as e.g. an ammonia slip catalytic converter ASC, which oxidizes surplus ammonia that may remain in the exhaust gases after passage through an SCR.

The components DOC, DPF, SCR catalytic converter, and ASC may, for example, be integrated in a single unit 130. Alternatively, the components can be arranged in any other suitable way manner, and one or more of said components can, for example, consist of separate units. Furthermore, the aftertreatment may include only one of said or other components or any combination of two or more components.

As was mentioned above, the present invention provides a method for controlling the combustion engine that, at least in some instances, may improve engine operation at least in some instance. For example, scavenging of hot residuals can be improved. Control of the combustion engine according to embodiments of the invention may also improve e.g. control of exhaust gas temperature. For example, operation of aftertreatment components of the kind described above, and perhaps in particular the SCR catalytic converter 204, are highly dependent on the prevailing temperature of the component. If the temperature of the component is too low, desired reactions may not occur and, conversely, if temperature is too high components may instead be damaged.

Embodiments of the present invention provides a method that may be used to influence the exhaust gas temperature of the exhaust gas entering aftertreatment components in a manner that is favourable to the temperature of the aftertreatment components. For example, the exhaust gas temperature can be reduced at high engine loads at low engine speeds through the use of scavenging according to embodiments of the invention. In addition, embodiments of the invention can, for example, be utilized to obtain increased exhaust temperatures, reduced exhaust flow and reduced NOₓ at low engine load and/or during coasting.

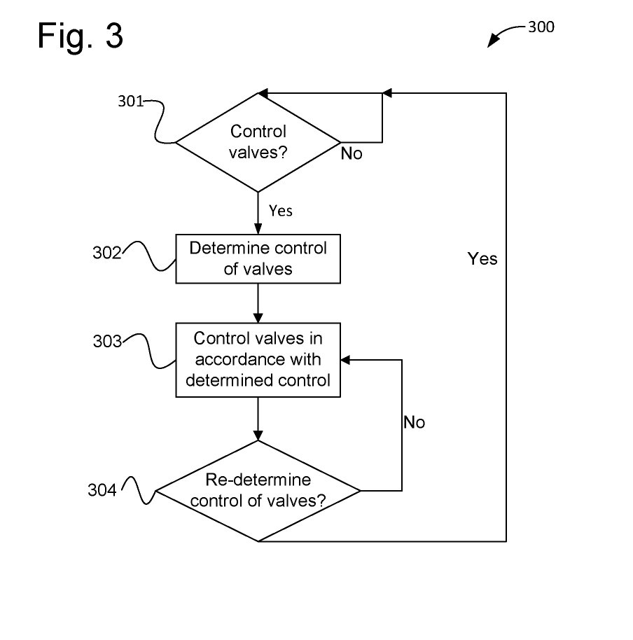

An exemplary method 300 of the present invention is shown in FIG. 3. The method can be implemented at least partly e.g. in the engine control unit 115 for controlling operation of the internal combustion engine 101. The functions of a vehicle are, in general, controlled by a number of control units, and control systems in vehicles of the disclosed kind generally comprise a communication bus system consisting of one or more communication buses for connecting a number of electronic control units (ECUs), or controllers, to various components on board the vehicle. Such a control system may comprise a large number of control units, and the control of a specific function may be divided between two or more of them.

For the sake of simplicity, FIG. 1A depicts only control units 115-116, 131, but vehicles 100 of the illustrated kind are often provided with significantly more control units, as one skilled in the art will appreciate. Control units 115-116, 131 are arranged to communicate with one another and various components via said communication bus system and other wiring, partly indicated by interconnecting lines in FIG. 1A.

The present invention can be implemented in any suitable control unit in the vehicle 100, and hence not necessarily in the control unit 115. The control influencing the valve opening and valve closing according to the present invention will usually depend on signals being received from other control units and/or vehicle components, and it is generally the case that control units of the disclosed type are normally adapted to receive sensor signals from various parts of the vehicle 100. The control unit 115 may, for example, receive signals e.g. from the control unit 131 and various sensors with regard to the control of the internal combustion engine 101.

Control units of the illustrated type are also usually adapted to deliver control signals to various parts and components of the vehicle, e.g. to control intake valve and exhaust valve according to the invention, e.g. by controlling phasers of camshafts. Operation of vehicle control systems per se is known to the person skilled in the art.

Furthermore, control of this kind is often accomplished by programmed instructions. The programmed instructions typically consist of a computer program which, when executed in a computer or control unit, causes the computer/control unit to exercise the desired control, such as method steps according to the present invention. The computer program usually constitutes a part of a computer program product, wherein said computer program product comprises a suitable storage medium 121 (see FIG. 1B) with the computer program 126 stored on said storage medium 121. The computer program can be stored in a non-volatile manner on said storage medium. The digital storage medium 121 can, for example, consist of any of the group comprising: ROM (Read-Only Memory), PROM (Programmable Read-Only Memory), EPROM (Erasable PROM), Flash memory, EEPROM (Electrically Erasable PROM), a hard disk unit etc., and be arranged in or in connection with the control unit, whereupon the computer program is executed by the control unit. The behaviour of the vehicle in a specific situation can thus be adapted by modifying the instructions of the computer program.

An exemplary control unit (the control unit 115) is shown schematically in FIG. 1B, wherein the control unit can comprise a processing unit 120, which can consist of, for example, any suitable type of processor or microcomputer, such as a circuit for digital signal processing (Digital Signal Processor, DSP) or a circuit with a predetermined specific function (Application Specific Integrated Circuit, ASIC). The processing unit 120 is connected to a memory unit 121, which provides the processing unit 120, with e.g. the stored program code 126 and/or the stored data that the processing unit 120 requires to be able to perform calculations. The processing unit 120 is also arranged so as to store partial or final results of calculations in the memory unit 121.

Furthermore, the control unit 115 is equipped with devices 122, 123, 124, 125 for receiving and transmitting input and output signals, respectively. These input and output signals can comprise waveforms, pulses or other attributes that the devices 122, 125 for receiving input signals can detect as information for processing by the processing unit 120. The devices 123, 124 for transmitting output signals are arranged so as to convert calculation results from the processing unit 120 into output signals for transfer to other parts of the vehicle control system and/or the component (s) for which the signals are intended. Each and every one of the connections to the devices for receiving and transmitting respective input and output signals can consist of one or more of a cable; a data bus, such as a CAN bus (Controller Area Network bus), a MOST bus (Media Oriented Systems Transport) or any other bus configuration, or of a wireless connection.

Returning to the exemplary method 300 illustrated in FIG. 3, the method starts in step 301, where it is determined whether intake valve and exhaust valve are to be controlled according to the invention. The method remains in step 301 for as long as this is not the case. The method continues to step 302 when it is determined that the valves are to be controlled according to the invention. The transition from step 301 to step 302 can, for example, be initiated according to various criteria. For example, the control can be arranged to be performed at all times, i.e. always when the internal combustion engine is started/in operation. Alternatively, control according to the invention can be arranged to be performed e.g. when certain conditions are fulfilled, e.g. with regard to vehicle internal operational conditions. Such conditions may, for example, relate to the current load of the internal combustion engine, and thereby the amount of work being produced, vehicle speed, internal combustion engine speed, ambient temperature, etc. Other criteria for performing the transition from step 301 to step 302 may also be applied.

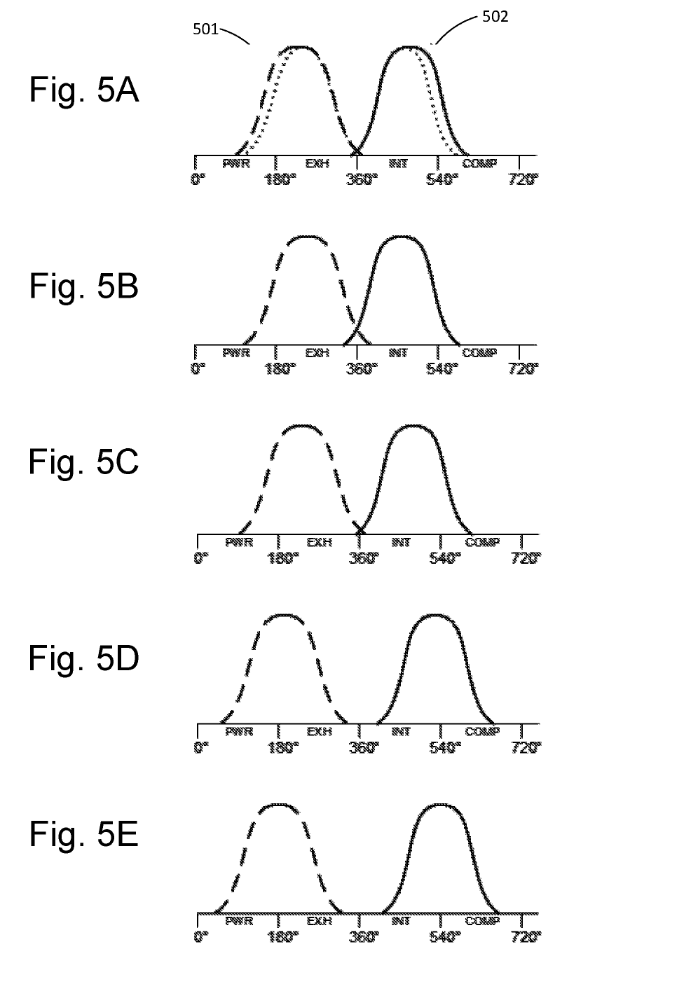

In step 302 a suitable control of the intake valves and exhaust valves is determined. This control may comprise control of at least EVC, i.e. exhaust valve closing, and IVO, i.e. intake valve opening. As was mentioned above, this control may depend on various operating conditions, where operation of the valves can be arranged to be controlled on the basis of internal combustion engine load and speed, or on the basis of additional or other factors. Following a description of an exemplary system, examples of such control will be discussed below with reference to FIG. 5A-E.

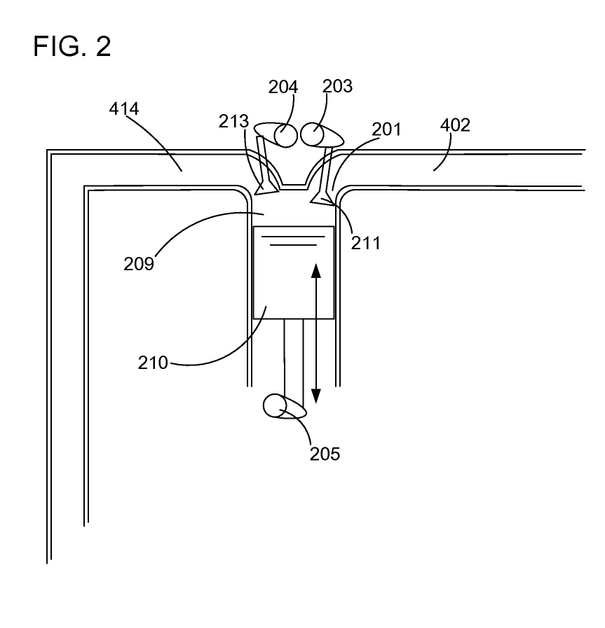

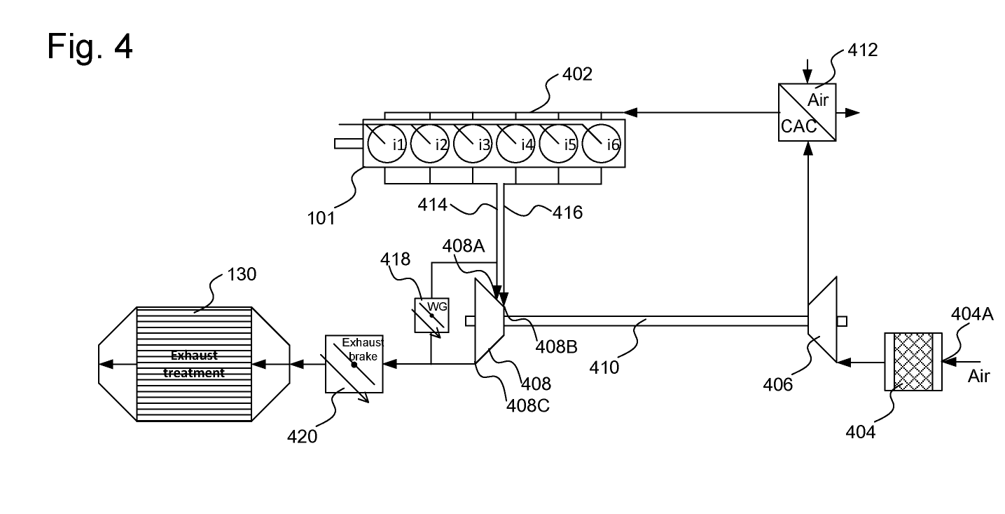

An exemplary combustion chamber 209 is shown in FIG. 2. The figure discloses only one cylinder/combustion chamber 209 in which a reciprocating piston is arranged 210. As will be shown in FIG. 4, the combustion engine 101 according to the present example constitutes an in-line six-cylinder internal combustion engine. The present invention may be utilized for combustion engines having any number of combustion chambers.

Internal combustion engines of the disclosed kind further comprises, in general, at least one fuel injector per combustion chamber (not shown) which in a conventional manner supplies fuel to the combustion chamber for combustion.

The combustion chamber 209 comprises an inlet 201 being controlled by one or more intake valves 211, which may be arranged to be individually controlled in relation to an exhaust valve 213 according to the below. Air for combustion is supplied to the combustion chamber by means of the intake valve 211 through an intake conduit 402, e.g. consisting of suitable piping, tubing and/or hosing, for receiving the air for supply to the combustion. In general, the air consists of air taken from the environment of the vehicle.

Evacuation of the combustion chamber 209 is controlled through an (or a plurality of) exhaust valve 213, which opens towards an exhaust manifold 414.

With regard to the exhaust valve 213 and intake valve 211 these are, in the present example, controlled individually by means of camshafts 203, 204, respectively, which, although being commonly driven by a crankshaft 205, are arranged to be individually phased in relation to each other so that opening time, closing time and possibly duration of the opening of the valves 211, 213 can be individually controlled for each valve. The phasing can, for example be accomplished by means of phasers. Use of phasers allows continuous adjustment of the valve control. For example, the phasers may be arranged such that each camshaft can be phase shifted up to e.g. 60, 80 or 100 crank angle degrees or any other suitable number of degrees, where phase shifting can selectively be e.g. both advancing and retarding, thereby allowing a relatively high degree of freedom when controlling the intake valve and exhaust valve in relation to each other.

The system is also shown in FIG. 4, which schematically shows all cylinders of the combustion engine, denoted i1-i6 in FIG. 4.

According to the disclosed example, ambient air from the vehicle/engine surrounding is drawn trough an air filter 404 from an intake side 404A of the air filter 404 being subjected to ambient air and being drawn through the air filter 404 by means of a compressor 406. The compressor 406 is driven by a turbine 408, the compressor 406 and turbine 408 being interconnected by means of a shaft 410, thereby forming a conventional turbocharger. The compressed air is cooled by a charge air cooler 412 in a manner known per se prior to being supplied to the intake conduit 402 and combustion chambers i1-i6 of the internal combustion engine 101.

Passage to the exhaust conduits of the combustion chambers i1-i6, are controlled by the exhaust valves of the combustion chambers, respectively. The exhaust conduits are further arranged such that exhaust gases emanating from cylinders i1-i3 share a common conduit 414 from exhaust outlets to a first inlet 408A of the turbine 408. Correspondingly, exhaust gases emanating from cylinders i4-i6 share a common conduit 416, separate from the conduit 414, from exhaust outlets to a second inlet 408B of the turbine 408. The turbine 408, consequently, comprises separate exhaust gas inlets for receiving the exhaust gas streams from conduits 414 and 416, respectively, e.g. constituting a conventional twin-scroll turbine.

The turbine 408 further constitutes a fixed geometry turbine, and a waste gate 418 is connected to either or both conduits 414, 416 for turbine bypass when required. An arrangement of this kind, i.e. an arrangement where separate exhaust conduits are used for each bank of combustion chambers, has the advantage that the pressure pulse consisting of exhaust from one combustion chamber will not disturb operation of another combustion chamber. If all six cylinders had been evacuated through a common exhaust conduit emanating close to the exhaust outlets of the combustion chambers, respectively, a pressure pulse when e.g. combustion chamber i4 opens to evacuate exhaust gases may travel and reach e.g. combustion chamber i1 at the time when this combustion chamber opens the exhaust valve. If in this situation the intake valve and exhaust valve of the combustion chamber i1 are simultaneously open the exhaust pulse may pass through combustion chamber i1 to the inlet side of the internal combustion engine 101. Such flow of exhaust gases is highly undesirable and can be avoided by separating the exhaust passages by dividing the combustion chambers into separate banks sharing separate exhaust manifolds, e.g. according to the present example.

The exhaust gas stream is then again combined and discharged by the turbine 408 through a single common outlet 408C and is led, in the present example via an exhaust brake 420, to the one or more aftertreatment components 130 for aftertreatment of exhaust gases according to the above prior to being released into the surroundings of the vehicle 100. According to the disclosed embodiment, an SCR catalytic converter is in itself capable of reducing nitric oxides to a desired extent and hence no further reduction is required. That is, no EGR recirculation is required. Systems of this kind may provide an additional degree of freedom in controlling the internal combustion engine, since EGR requirements regarding pressure differences between intake side and exhaust side of the internal combustion engine need not be accounted for.

As was mentioned above, a suitable control of the valves is determined in step 302, and FIGS. 5A-E shows exemplary control methods that may be utilized according to the invention. The dashed lines represent the exhaust valve, and the solid lines represent the intake valve. The y-axis represent state of the valve, where the zero level represents a fully closed valve, and the other levels at least partially open valve, where physically fully open occurs at the top of the curve, but the fully open position in terms of flow may occur earlier. According to the invention, the valves are considered “open” when they are not fully closed, i.e. as soon as they have started to open and until they again are in closed position. The x-axis represent movement, expressed in crank shaft degrees and 0, 360, 720 representing piston position TDC.

Furthermore, according to embodiments of the invention, camshafts are used that have a prolonged opening time in comparison to conventional camshafts. This is not a requirement according to the invention, but in addition to the individually controllable cam phasing, this provides additional advantages and possibilities in the control of the opening and closing of the intake and exhaust valves.

This is illustrated in FIG. 5A. Exemplary “normal” cam profiles are shown in dotted lines, which, according to embodiments of the invention, are replaced by cam profiles with longer duration. This is represented by dashed (exhaust valve) and solid (intake valve) lines. Consequently, as can be seen from FIG. 5A, if exhaust valve 501 closing and intake valve 502 opening take place at a particular position, camshafts providing extended opening times will result in the exhaust valve opening earlier, and the intake valve closing later. The opening times of the “normal” cam profiles may be 190-195, e.g. 193, crank shaft degrees for the intake valve, and 200-205, e.g. 204, crank shaft degrees for the exhaust valves. The opening times of according to embodiments of the invention may be 203-215, e.g. 213, crank shaft degrees for the intake valve, and 210-225, e.g. 224, crank shaft degrees for the exhaust valves.

FIG. 5B shows an example of valve control which may be utilized in situations where the exhaust gas stream resulting from combustion in the combustion chambers reaches temperatures that may damage aftertreatment components. The risk for this to occur may perhaps be the greatest for operation at low engine speeds while simultaneously a high torque is delivered by the internal combustion engine. Also, the control of FIG. 5B can be utilized in general for all medium to high loads at low to medium engine speeds to improve scavenging of residuals and/or improve vehicle performance as mentioned above by increasing flow and thereby turbine rotation.

According to FIG. 5B, exhaust valve/intake valve overlap at TDC 360° enables scavenging of residuals, and in the particular example both camshafts are phased approximately 15° toward more overlap, i.e. being phased in opposite directions where the exhaust camshaft is retarded and the intake camshaft is advanced, to thereby obtain a total increased overlap of approximately 30° so that intake air is allowed to pass through the combustion chamber and directly to the outlet to improve evacuation of the exhausts.

Also, as was mentioned above, this increases brake thermal efficiency so that larger amounts of intake air can be supplied, and thereby larger amounts of fuel, if desired. The valve overlap is accomplished by retarding the camshaft controlling the exhaust valve, while simultaneously advancing the camshaft controlling the intake valve. According to the disclosed example, this corresponds to the extended duration, i.e. approx. 15°, which has the result that the exhaust valve still opens at the “normal” position, and the intake valve closes at the “normal” position. According to the disclosed example, the phasing is symmetrical, i.e. both camshafts are phase shifted to an equal extent albeit in different directions. This, however, need not be the case and the camshafts may be phased to different extents. Also, the phasing may be considerably higher than in the present example, so that longer periods of simultaneously open valves are obtained. This is also exemplified further below.

The passage of intake air to the exhaust side reduces exhaust temperature, which may be beneficial to e.g. temperature sensitive aftertreatment components. Furthermore, the increased efficiency in evacuating hot residuals means, as was explained above, that more intake air can be supplied, and hence torque can be increased for low/medium engine speeds. Also, the increased flow will improve transient performance by decreasing turbo lag.

FIG. 5C shows essentially the phasing of FIG. 5A, where EVO and IVC are controlled such that there is essentially no overlap, but where the extended valve-open durations result in early exhaust valve opening (EEVO) and late intake valve closing (LIVC). This kind of phasing, where the camshafts are phased toward to conventional EVO and IVC may be utilized e.g. at medium to high engine speed position to improve, inter alia, brake thermal efficiency (BTE). The combination of LIVC+EEVO is beneficial. EEVO increases the time-window available to evacuate the exhaust gases and according to the disclosed example the exhaust valve opens already during the power stroke. Consequently, the pressure in the cylinder is lower when the piston reaches bottom dead centre (BDC) and starts its upward exhaust stroke making this stroke less power consuming, i.e. increasing open cycle efficiency, OCE.

LIVC, in turn, reduces mass flow through the engine, which reduces pumping work and increases OCE. Because of higher engine speed the time available for heat loss is shorter and since air/fuel ratio lambda A is sufficiently high the loss in closed cycle efficiency, CCE, due to less bulk mass is smaller than the OCE gain.

FIG. 5D discloses a further example of valve control which can be utilized e.g. at low engine load. According to this example, the camshafts are each phased approx. 45° towards a negative overlap, i.e. the exhaust cam shaft is advanced while the intake camshaft is retarded, where the exhaust valve closes well before the intake valve opens. This kind of control can be utilized to reduce air/fuel ratio lambda A, exhaust flow and NOₓ.

FIG. 5E shows an exemplary maximum phasing of, according to the present example, approximately 55°/55°. Maximum phasing may be beneficial to use e.g. when the vehicle is coasting, in particular when coasting with the engine rotating and the transmission in gear without fuel supply. During coasting cold air will be flushed through the engine without undergoing substantially any heating and thereby subject the aftertreatment components to substantial cooling. The use of maximum negative phasing can be used to minimize flow across the engine cooling of the exhaust treatment system. If the intake valve is open through most or all of the compression stroke the flow through the engine can be reduced to essentially zero.

Furthermore, the examples shown in FIGS. 5A-E discloses an additional feature that may or may not be utilized, and which may be utilized to different extents through control of in particular the intake valve. As can be seen from the figure, the intake valve closes after the piston has reached BDC, and hence after the compression stroke is commenced. This means that as the piston moves upwards in the compression stroke while the intake valve is still open the charge is partially expelled back into the intake manifold through the open intake valve. The use of such control in combination with supercharged intake air is called Miller-cycle. Operation according to the Miller-cycle may be advantageous. For example, the Miller-cycle may be utilized to “reduce” the effective volume of the combustion chamber by creating a virtual BDC at a position between actual BDC and TDC, so that the engine appears smaller than actually is the case. In this way, the same hardware may be used to be operated as engines having different cylinder volumes, i.e. the full capacity of the engine need not be utilized.

When a suitable control has been determined in step 302, e.g. according to any of the examples disclosed in FIGS. 5A-E or any other suitable control, the method continues to step 303 where the control is commenced by operating, in this case phasing, the camshafts 203, 204 in accordance with the control determined in step 302 to obtain the desired operation of the exhaust valve and intake valve. The valves of all combustion chambers are simultaneously controlled by the camshafts operating all valves in a conventional manner.

It may then be determined whether the control is to be determined anew, e.g. due to changed or changing operating conditions, in which case the method returns to step 301. Otherwise the method returns to step 303 to continue control according to determined parameters. According to the invention, consequently, the valves can be arranged to be continuously controlled to account for prevailing conditions so that operation of the internal combustion engine can be controlled in an efficient manner, e.g. with advantages as set out above.

In addition to the above, the present invention may further be used in combination with the solutions described in the Swedish patent application 1550976, title “METHOD AND SYSTEM FOR CONTROLLING EXHAUST GASES RESULTING FROM COMBUSTION” and Swedish patent application 1550978, title “METHOD AND SYSTEM FOR CONTROLLING AN INTERNAL COMBUSTION ENGINE”.

SE1550976 relates to situations where undesired temperatures may arise. According to SE1550976, exhaust gas temperatures are controlled by a method (and system) by means of which air from the intake side of the internal combustion engine is arranged to bypass the combustion chambers for mixing with the exhaust gases when hot exhaust gases are expected. In this way, hot exhaust gases can be cooled off in situations when hot exhaust gases may damage temperature sensitive components.

Furthermore, at least part of exhaust gases resulting from said combustion are recirculated uncooled to said intake side when the temperature is such that exhaust gases may otherwise cool off aftertreatment components to an extent where proper operation no longer can be ensured.

EGR like circuitry can be used to effect circulation according to the above, where only gases from combustion chambers in which no combustion has been carried out can be recirculated.

SE1550978 relates to situations where it might be difficult to maintain an exothermic, i.e. temperature increasing, reaction in, for example, an oxidation catalyst that is used to oxidize remaining unburned fuel in the exhaust gases.

According to SE1550978, an exothermic reaction is upheld when cold exhaust gases may cool off aftertreatment components. This is accomplished by supplying unburned fuel to exhaust gases discharged by some combustion chambers through fuel injection into only part of the combustion chambers of a combustion engine.

Furthermore, at least part of exhaust gases discharged by combustion chambers being distinct from the combustion chambers into which fuel is injected are recirculated to the intake side of the internal combustion engine, where the exhaust gases are being recirculated at least substantially uncooled.

The solutions provided by the present invention may be combined with the solution described in said applications e.g. to enhance further operation of the internal combustion engine.

Finally, the present invention has been exemplified for a vehicle. The invention is, however, applicable in any kind of craft, such as, e.g., aircrafts and watercrafts. The invention is also applicable for use in combustion plants.

1. A method for controlling a compression-ignition internal combustion engine, said internal combustion engine having at least one combustion chamber wherein intake of air to said combustion chamber is controlled using an intake valve, and wherein evacuation of said combustion chamber is controlled using an exhaust valve, the method comprising:
controlling opening of said intake valve and closing of said exhaust valve in dependence of the position of a reciprocating member in said combustion chamber, wherein, opening of said intake valve and closing of said exhaust valve, respectively, in relation to the position of said reciprocating member is individually controllable;
wherein, in one mode of operation, opening of said intake valve and closing of said exhaust valve, respectively, are controlled such that both valves are simultaneously open during a period of variable length, so that intake air passes through the combustion chamber and simultaneously mixes with and evacuates exhaust residuals.

2. A method according to claim 1, further comprising:
controlling said intake valve and said exhaust valve such that opening of said intake valve and closing of said exhaust valve, respectively, is performed at varying positions of said reciprocating member in said combustion chamber.

3. A method according to claim 1, further comprising:
controlling opening of said intake valve and closing of said exhaust valve in dependence of work produced by said internal combustion engine, and/or rotational speed of said internal combustion engine.

4. A method according to claim 1, further comprising:
controlling opening of said intake valve and closing of said exhaust valve such that intake air passes through the combustion chamber and simultaneously mixes with and evacuates exhaust residuals so that exhaust residuals remaining in the combustion chamber are reduced when a rotational speed is below a first speed and/or when a work produced by said internal combustion engine exceeds a first work.

5. A method according to claim 1, further comprising:
according to a first mode of operation controlling opening of said intake valve and closing of said exhaust valve such that both valves are simultaneously open during a first period; and
according to a second mode of operation, controlling opening of said intake valve and closing of said exhaust valve such that both valves are simultaneously open during a second period, being different from said first period.

6. A method according to claim 5, wherein work produced by said combustion engine in said first mode of operation exceeds work produced by said combustion engine in said second mode of operation, and wherein said first period exceeds said second period.

7. A method according to claim 1, further comprising:
according to a first mode of operation controlling opening of said intake valve and closing of said exhaust valve such that both valves are simultaneously open during a first period of time; and
according to a second mode of operation, the intake valve and exhaust valve are controlled such that the exhaust valve closes prior to the intake valve opens.

8. A method according to claim 1, further comprising:
according to a first mode of operation controlling opening of said intake valve and closing of said exhaust valve such that both valves are simultaneously open during a first period; and
according to a second mode of operation, controlling said intake valve such that said intake valve closes after the beginning of a compression stroke.

9. A method according to claim 1, wherein the position of the reciprocating member in the combustion chamber is represented by a crank shaft position, wherein a crank shaft degree at which an intake valve opens, and a crank shaft degree at which the exhaust valve closes can be controlled.

10. A method according to claim 1, wherein a first camshaft is used to control opening and closing of said exhaust valve, and a second camshaft is used to control opening and closing of the intake valve.

11. A method according to claim 10, wherein opening of said intake valve and closing of said exhaust valve are controlled by individually phasing said first and second cam shaft.

12. A method according to claim 10, further comprising
individually phasing said camshafts any number of crank shaft degrees in an interval of 10-100 degrees.

13. A method according to claim 10, wherein opening of said intake valve is controlled by controlling a the crank angle at which the intake valve opens and where closing of said exhaust valve is controlled by controlling a crank angle at which the exhaust valve closes.

14. A method according to claim 1, said internal combustion engine comprising a plurality of combustion chambers, said combustion chambers being divided into at least two banks, each of said banks comprising a separate exhaust conduit for exhaust gases resulting from said bank.

15. (canceled)

16. A computer program product stored on a non-transitory computer-readable medium, said computer program product for controlling a compression-ignition internal combustion engine, said internal combustion engine having at least one combustion chamber, wherein intake of air to said combustion chamber is controlled using an intake valve, and wherein evacuation of said combustion chamber is controlled using an exhaust valve, said computer program product comprising computer instructions to cause one or more electronic control units or computers to perform the following operations:
controlling opening of said intake valve and closing of said exhaust valve in dependence of the position of a reciprocating member in said combustion chamber, wherein, opening of said intake valve and closing of said exhaust valve, respectively, in relation to the position of said reciprocating member is individually controllable; and
wherein, in one mode of operation, opening of said intake valve and closing of said exhaust valve, respectively, are controlled such that both valves are simultaneously open during a period of variable length, so that intake air passes through the combustion chamber and simultaneously mixes with and evacuates exhaust residuals.

17. A system for controlling a compression-ignition internal combustion engine, said internal combustion engine having at least one combustion chamber, wherein intake of air to said combustion chamber is controlled using an intake valve, and wherein evacuation of said combustion chamber is controlled using an exhaust valve, the system comprising:
control means adapted to control opening of said intake valve and closing of said exhaust valve in dependence of the position of a reciprocating member in said combustion chamber, wherein, opening of said intake valve and closing of said exhaust valve, respectively, in relation to the position of said reciprocating member is adapted to be individually controllable, and
wherein, in one mode of operation, opening of said intake valve and closing of said exhaust valve, respectively, are adapted to be controlled such that both valves are simultaneously open during a period of variable length, so that intake air passes through the combustion chamber and simultaneously mixes with and evacuates exhaust residuals.

18. A system according to claim 17, wherein the engine and a turbocharger combination is designed such that the efficiency of a compressor of the turbocharger increases with increasing mass flow through the compressor and/or a turbine of the turbocharger.

19. A system according to claim 17, wherein said internal combustion engine comprises a plurality of combustion chambers, said combustion chambers being divided into at least two banks, each of said banks comprising a separate exhaust manifold for exhaust gases resulting from said bank, the system further comprising a bank separating turbine, wherein the bank separating turbine comprises either a turbine having separate inlets for each of said banks, or separate turbochargers for each bank.

20. A system according to claim 17, wherein the internal combustion engine consists of an internal combustion engine without exhaust gas recirculation (EGR) conduit for recirculating exhausts from exhaust conduit to intake conduit.

21. A vehicle comprising a system for controlling a compression-ignition internal combustion engine, said internal combustion engine having at least one combustion chamber, wherein intake of air to said combustion chamber is controlled using an intake valve, and wherein evacuation of said combustion chamber is controlled using an exhaust valve, the system comprising:
control means adapted to control opening of said intake valve and closing of said exhaust valve in dependence of the position of a reciprocating member in said combustion chamber, wherein, opening of said intake valve and closing of said exhaust valve, respectively, in relation to the position of said reciprocating member is adapted to be individually controllable, and
wherein, in one mode of operation, opening of said intake valve and closing of said exhaust valve, respectively, are adapted to be controlled such that both valves are simultaneously open during a period of variable length, so that intake air passes through the combustion chamber and simultaneously mixes with and evacuates exhaust residuals.
